(19) United States
(12) Patent Application Publication
(10) Pub. No.: US 2003/0171937 A1
(43) Pub. Date: Sep. 11, 2003

(54) Apparatus for reproducing encoded digital audio signal at variable speed

(75) Inventor: Masakazu Fukumoto, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/379,918

(22) Filed: Mar. 6, 2003

(30) Foreign Application Priority Data
Mar. 6, 2002 (JP) 2002-060472

(51) Int. Cl. G10L 21/00; G10L 19/14; G10L 21/04

(52) U.S. Cl. 704/503; 704/205

(57) ABSTRACT

A variable-speed reproduction apparatus for reproducing an encoded digital audio signal is equipped with a signal supplier to accept an encoded digital audio signal with a frequency spectrum per block of the encoded audio and output the encoded digital audio signal at a desired speed, and a frequency-spectrum processor to perform mapping to frequency-spectrum components of the output encoded digital audio signal based on the desired speed, thus generating a processed frequency spectrum.

### CROSS REFERENCE TO RELATED APPLICATION

This application is based upon and claims the benefit of priority from the prior Japanese Patent Application No. 2002-060472, filed on Mar. 6, 2002, the entire contents of which are incorporated herein by reference.

### BACKGROUND OF THE INVENTION

The present invention relates to an apparatus for reproducing encoded digital audio signals at variable speeds. Especially, this invention relates to an apparatus for reproducing encoded digital audio signals at variable speeds with pitch variation by shifting frequency spectra of the audio signals.

Several types of encoded-signal reproducing apparatus have beenproposed. Theseapparatusreproduceencodeddigitalsignals from storage media that have stored several contents such as data, video and audio.

Among them, encoded-digital-audio signal reproducing apparatus such as MPEG (Moving Picture Experts Group) audio decoders are used for reproduction of encoded digital audio signals.

One of the conventional encoded-digital-audio signal reproducing apparatus is a (1× speed)-reproducing apparatus for reproducing encoded digital audio signals (or compressed audio bitstream) at the recorded speed.

Reproduction of audio signals at a speed the same as when the audio signals have been recorded is called (1× speed)-reproduction hereinafter.

FIG. 10 shows a block diagram of a conventional (1× speed)-reproducing apparatus 1 for reproducing encoded digital audio signals.

The (1× speed)-reproducing apparatus 1 is equipped with an encoded-digital-audio signal supplier (abbreviated into EDAS supplier hereinafter) 2 for accepting an encoded digital audio signal (compressed audio bitstream) S1 and supplying the signal S1 ginto the apparatus 1; an auxiliary-data retriever (abbreviated into AUX-DATA retriever hereinafter) 3 for retrieving an auxiliary data from the audio signal S1; a frequency-spectrum extractor (abbreviated into SPEC extractor hereinafter) 4 for extracting a frequency-spectral data carried by the audio signal S1 gbased on the auxiliary data; a frequency-domain to time-domain converter (abbreviated into FD/TD converter hereinafter) 5 for converting frequency components of the signal S1 ginto time components based on the auxiliary and frequency-spectral data, thus outputting a digital audio signal S2; and a digital-to-analog converter (abbreviated into D/A converter hereinafter) 6 for converting the digital audio signal S2 into an analog audio signal S3.

Explained below is (1× speed)-reproduction of a compressed audio bitstream in the known reproducing apparatus 1.

A compressed audio bitstream is sent to the EDAS supplier 2 from a storage medium or through a transfer line.

The compressed audio bitstream is supplied to the AUX-DATA retriever 3 and the SPEC extractor 4 from the EDAS supplier 2. The AUX-DATA retriever 3 retrieves parameters required for decoding per block from the compressed audio bitstream. The SPEC extractor 4 extracts a frequency spectrum per block from the compressed audio bitstream with referring to the parameters, etc.

The FD/TD converter 5 converts the frequency spectrum per block into a time-domain signal by orthogonal transform, etc., with referring to the parameters, etc. Moreover, the FD/TD converter 5 multiplies the time-domain signal for the current block and also another time-domain signal for the preceding block by window functions and adds the function-multiplied time-domain signals to one another, thus producing a decoded digital audio signal per block. This process is called window and overlapping processing hereinafter.

The decoded digital audio signal is converted into an analog audio signal by the D/A converter 6 and played back through speakers, etc.

The analog audio signal reproduced as above has a sine waveform as illustrated in FIG. 11(b) when the frequency spectrum shown in FIG. 11(a) is subjected to frequency domain to time-domain conversion in the (1× speed)-reproducing apparatus 1.

Variable-speed reproduction based on the sine waveform shown in FIG. 11(b) gives several sine waveforms. For example, (2× speed)-reproduction of the sine waveform in FIG. 11(b) gives a sine waveform, such as shown in FIG. 11(c), as if compressed on the time axis. On the contrary, (½× speed)-reproduction of the sine waveform in FIG. 11(b) gives a sine waveform, such as shown in FIG. 11(d), as if expanded on the time axis.

The (1× speed)-reproducing apparatus shown in FIG. 10 has the following drawbacks when variable-speed reproduction is performed.

For example, the time-compressed sine waveform shown in FIG. 11(c) suffers high pitch when played back. Contrary to this, the time-expanded sine waveform shown in FIG. 11(d) suffers low pitch when played back. Users could feel uncomfortable in either case.

Another conventional variable-speed reproducing apparatus 7 is shown in FIG. 12, which corresponds to the (1× speed)-reproducing apparatus 1 shown in FIG. 10, with a known variable-speed reproducing function.

Explained below with reference to FIG. 12 is (1/N× speed)-reproduction of a compressed audio bitstream under a known technique. (1/N× speed)-reproduction is variable-speed reproduction at a speed 1/N (N being an integer) times slower than in (1× speed)-reproduction.

The known variable-speed reproducing apparatus 7 is equipped with an EDAS supplier 2 for accepting an encoded digital audio signal S1 gand supplying the signal S1 ginto the apparatus 7; an AUX-DATA retriever 3 for retrieving an auxiliary data from the audio signal S1; an SPEC extractor 4 for extracting a frequency-spectral data carried by the audio signal S1 based on the auxiliary data; an FD/TD converter 5 for converting frequency components of the signal S1 into time-domain components based on the auxiliary and frequency-spectral data, thus outputting a digital audio signal S2; and also a D/A converter 6 for converting the digital audio signal S2 into an analog audio signal S3, the same as the known (1× speed)-reproducing apparatus 1.

The differences between the variable-speed reproducing apparatus 7 and the (1× speed)-reproducing apparatus 1 are as follows: the former apparatus 7 has a sampling repeater 8 provided between the FD/TD converter 5 and the D/A converter 6; and a variable-speed reproduction controller (abbreviated into VSR controller hereinafter) 9 provided between the EDAS supplier 2 and the repeater 8, for supplying a control signal thereto.

In detail, the VSR controller 9 supplies a (1/N× speed)-reproduction control signal to the EDAS supplier 2 and the repeater 8.

The EDAS supplier 2 accepts a compressed digital audio signal and supplies the audio bitstream to the AUX-DATA retriever 3 and the SPEC extractor 4 at a rate (speed) 1/N times lower than (1× speed)-reproduction.

The AUX-DATA retriever 3, the FS extractor 4 and the FD/TD converter 5 perform the same processing as the counterparts shown in FIG. 10 in (1× speed)-reproduction.

Analog audio output directly via the D/A converter 6 suffers 1/N reduction in pitches, thus unlistenable to users.

In order to overcome such a disadvantage, the repeater 8 accepts the digital audio signal S2 per block from the FD/TD converter 5 and outputs it N times.

During the repeated output per block, the sampling repeater 8 performs fade-in and fade-out processing at the beginning and completion of output repetition per block. The fade-in and -out processing suppresses noises which could be generated due to discontinuity in the digital audio signal S2 between two consecutive repeated outputs. This is (1/N× speed)-reproduction with repeated output processing under a known technique.

High sound quality may be achieved with cross-fade processing for noise suppression over two or more of consecutive repeated outputs. This processing, however, increases the number of output repetition equal to the sampling times for the noise-suppressed digital audio signal.

High sound quality may further be achieved with N-times output repetition per M blocks (M being an integer).

FIGS. 13(a) to 13(d) illustrate signal reproduction in the known variable-speed reproducing apparatus shown in FIG. 12. Shown in FIGS. 13(b) to 13(d) are waveforms reproduced at different speeds based on a sine-wave spectrum shown in FIGS. 13(a). In detail, FIGS. 13(b), 13(c) and 13(d) show waveforms under (1× speed)-, (2× speed)- and (½× speed)-reproduction, respectively.

The conventional variable-speed reproducing apparatus described above has the following three disadvantages:

The first disadvantage lies in the sampling repeater 8 for cross-fade processing over consecutive repeated outputs for high-quality sound variable-speed reproduction. The cross-fade processing causes bulk circuitry or software, which results in increase in manufacturing cost, operational delay, etc.

The second disadvantage lies in large storage capacity. In detail, a large capacity memory is required for temporarily storing audio signals for several hundred milliseconds. This is because output repetition should be performed per several hundred milliseconds in high-quality (1/N× speed)-reproduction. Such a large capacity memory also increases costs for manufacturing variable-speed reproducing apparatus.

The third disadvantage lies in difficulty in all-time stable high-quality sound variable-speed reproduction. For example, music and speeches are different fromeach other in optimum interval for output decimation and repetition. This causes unlistenable speeches when played back with music at output-decimation and repetition intervals optimum for music. Such unlistenable output cannot fulfill the requirement for sound quality relatively high even in variable-speed reproduction.

### SUMMARY OF THE INVENTION

A variable-speed reproduction apparatus for reproducing an encoded digital audio signal according to an embodiment of the invention includes a signal supplier to accept an input encoded digital audio signal with a frequency spectrum per block of the encoded audio and output the encoded digital audio signal at a desired speed; and a frequency-spectrum processor to perform mapping to frequency-spectrum components of the output encoded digital audio signal based on the desired speed, thus generating a processed frequency spectrum.

An audio reproduction system according to an embodiment of the invention, has a signal reader to retrieve an encoded audio digital signal from a storage medium storing MPEG audio signals, an MPEG audio decoder to decode the retrieved encoded audio digital signal at a desired speed among an original speed the same as a speed at which the MPEG audio signals have been stored in the storage medium, a speed of 1/N times lower than the original speed and a speed of N times higher than the original speed (N being a positive integer), and a speaker to output audio based on a digital or an analog audio signal reproduced by the MPEG audio decoder, wherein the MPEG audio decoder comprises a signal supplier to accept the encoded digital audio signal with a frequency spectrum per block of the encoded audio and output the encoded digital audio signal at the desired speed, and a frequency-spectrum processor to perform mapping to frequency-spectrum components of the output encoded digital audio signal based on the desired speed, thus generating a processed frequency spectrum.

### BRIEF DESCRIPTION OF THE DRAWINGS

In the drawings:

FIG. 1 shows a block diagram indicating an outline structure of a variable-speed reproducing apparatus for reproducing encoded digital audio signals according to a first embodiment of the present invention;

FIG. 2 illustrates formulas indicating an operation of a frequency-spectrum processor with zeros allocated to frequency-spectrum components not to be subjected to remapping to avoid shortage of remapped components;

FIG. 3 shows frequency spectrum characteristics in frequency-spectrum processing according to the embodiments the present invention to typical audio signals, with (a) a frequency spectrum of an original signal and (b) a frequency spectrum of a double-remapped signal;

FIG. 4 shows sine waveforms for easy understanding of the frequency-spectrum processing according to an embodiment of the present invention, with (a) a frequency spectrum of sine waves of an original signal, (b) a frequency spectrum of sine waves of a double-remapped signal, (c) a digital audio signal waveform based on frequency-domain to time-domain conversion to the original sine wave, (d) a digital audio signal waveform based on frequency-domain to time-domain conversion to double-remapped sine waves, and (e) an analog audio signal waveform based on digital-to-analog conversion to the waveform (d) at a sampling frequency ½ lower than that of the waveform (d);

FIG. 5 shows the correspondence between (a) a remapped frequency-spectrum component and digital audio signals under (b) (1× speed)- reproduction, (c) (2× speed)-reproduction and (d) (½× speed)-reproduction to the spectrum component;

FIG. 6 illustrates frequency-spectrum remapping in (½× speed)-reproduction;

FIG. 7 illustrates frequency-spectrum remapping in (2× speed)-reproduction;

FIG. 8 illustrates formulas indicating an operation of a frequency-spectrum processor with generation of frequency-spectrum components to avoid shortage of remapped components from frequency-spectrum components on both sides of each frequency-spectrum component not to be subjected to remapping;

FIG. 9 shows a block diagram of an audio reproduction system equipped with an MPEG audio recorder employing a variable-speed reproducing apparatus according to an embodiment the present invention;

FIG. 10 shows a block diagram of a known variable-speed reproducing apparatus for reproducing encoded digital audio signals;

FIG. 11 shows the correspondence between (a) a frequency-spectrum component and sine waveforms under (b) (1× speed)-reproduction, (c) (2× speed)-reproduction and (d) (½× speed)-reproduction, in the known variable-speed reproducing apparatus shown in FIG. 10;

FIG. 12 shows a block diagramof another known variable-speed reproducing apparatus for reproducing encoded digital audio signals; and

FIG. 13 shows the correspondence between (a) a frequency-spectrum component and sine waveforms under (b) (1× speed)- reproduction, (c) (2× speed)- reproduction and (d) (½× speed)-reproduction, in the known variable-speed reproducing apparatus shown in FIG. 12.

### DETAIILED DESCRIPTION OF THE INVENTION

Embodiments of variable-speed reproducing apparatus for reproducing encoded digital audio signals according to the present invention will be disclosed in detail with reference to the attached drawings.

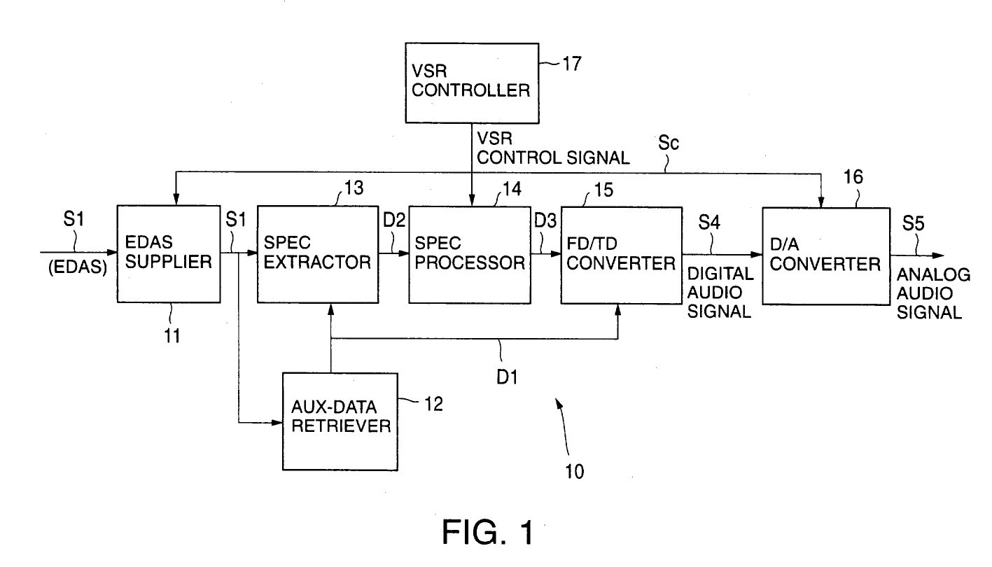

FIG. 1 is a block diagram indicating an outline structure of a variable-speed reproducing apparatus 10 for reproducing encoded digital audio signals according to a first embodiment of the present invention.

The following disclosure for the variable-speed reproducing apparatus 10 for reproducing encoded digital audio signals according to the first embodiment is made for (½× speed)-reproduction (N=2) at a sampling frequency of 44.1 KHz.

The variable-speed reproducing apparatus 10 shown in FIG. 1 is equipped with an encoded-digital-audio signal supplier (abbreviated into EDAS supplier hereinafter) 11 for accepting. an encoded digital audio signal S1 and supplying the signal S1 into the apparatus 10; an auxiliary-data retriever (abbreviated into AUX-DATA retriever hereinafter) 12 for retrieving an auxiliary data DI from the audio signal S1; a frequency-spectrum extractor (abbreviated into SPEC extractor hereinafter) 13 for extracting a frequency-spectral data D2 carried by the audio signal S1 based on the auxiliary data D1; a frequency-spectrum processor (abbreviated into SPEC processor hereinafter) 14 for processing the frequency spectrum based on the frequency-spectral data D2, thus outputting a processed-frequency-spectral data D3; a frequency-domain to time-domain converter (abbreviated into FD/TD converter hereinafter) 15 for converting frequency components of the signal S1 into time-domain components based on the auxiliary data D1 and the processed-frequency-spectral data D3, thus outputting a digital audio signal S4; a digital-to-analog converter (abbreviated into D/A converter hereinafter) 16 for converting the digital audio signal S4 into an analog audio signal S5; and a variable-speed reproduction controller (abbreviated into VSR controller hereinafter) 17 for supplying a variable-speed reproduction control signal (abbreviated into VSR control signal hereinafter) Sc to the EDAS supplier 11, the FS processor 14 and the D/A converter 16.

The EDAS supplier 11, the AUX-DATA retriever 12, the SPEC extractor 13 and the FD/TD converter 15 perform the same processing as the counterparts in the known variable-speed reproducing apparatus already described.

The VSR controller 17 supplies the VSR control signal Sc for (½× speed)-reproduction to the EDAS supplier 11, the SPEC processor 14 and the D/A converter 16.

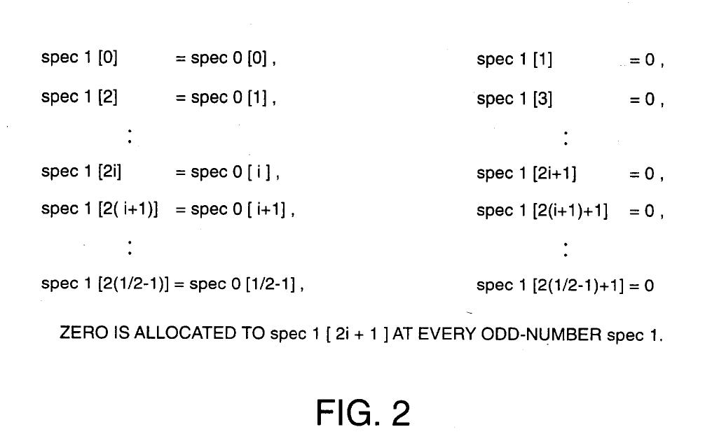

Under control by the (½× speed)-reproduction VSR control signal Sc, the SPEC processor 14 receives a frequency spectrum per block from the SPEC extractor 13 and performs double remapping for the frequency-spectrum components. The double remapping is expressed by formulas shown in FIG. 2 as equations in which spec0[i] is an original i-th frequency-spectrum component, spec1[i] is a remapped i-th frequency-spectrum component and I is the total number of spectrum components.

The frequency spectrum remapped in double is supplied to the FD/TD converter 15 for frequency-domain to time-domain conversion per block the same as (1× speed)-reproduction.

The digital audio signal S4 subjected to frequency-domain to time-domain conversion per block is supplied to the D/Aconverter 16. D/A conversion is performed at a sampling frequency of 44.1 KHz in (1× speed)-reproduction. It is, however, performed at 22. 05 KHz, one-half of the sampling frequency in (1× speed)-reproduction, under control by the (½× speed)-reproduction VSR control signal Sc from the VSR controller 17.

As disclosed, the SPEC processor 14 remaps the frequency spectrum of the encoded digital audio signal S1 by N times. It further allocates zero to frequency-spectrum components not to be subjected to remapping to avoid shortage of remapped components.

Moreover, the D/A converter 16 performs D/A conversion at a sampling frequency 1/N times lower than in (1× speed)-reproduction.

The processing described above achieves (1/N× speed)-reproduction with no pitch variation.

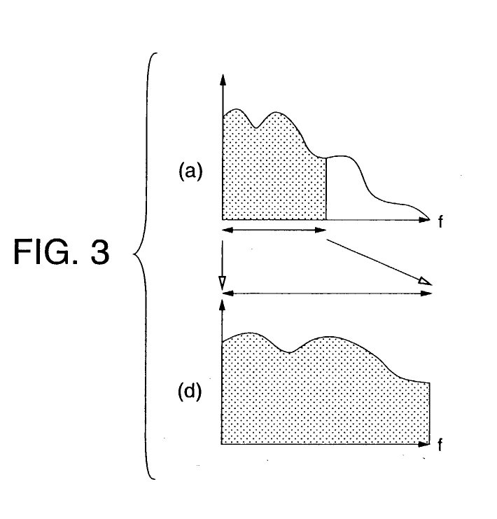

FIGS. 3(a) and 3(b) illustrate frequency-spectrum processing according to an embodiment of the present invention for typical audio signals.

Shown in FIG. 3(a) is a typical audio-signal frequency spectrum. Remapping a frequency spectrum indicated with a dot pattern in FIG. 3(a) in double gives a frequency spectrum as being expanded as shown in FIG. 3(b).

The double remapping will be explained below for a sine-wave signal for easy understanding.

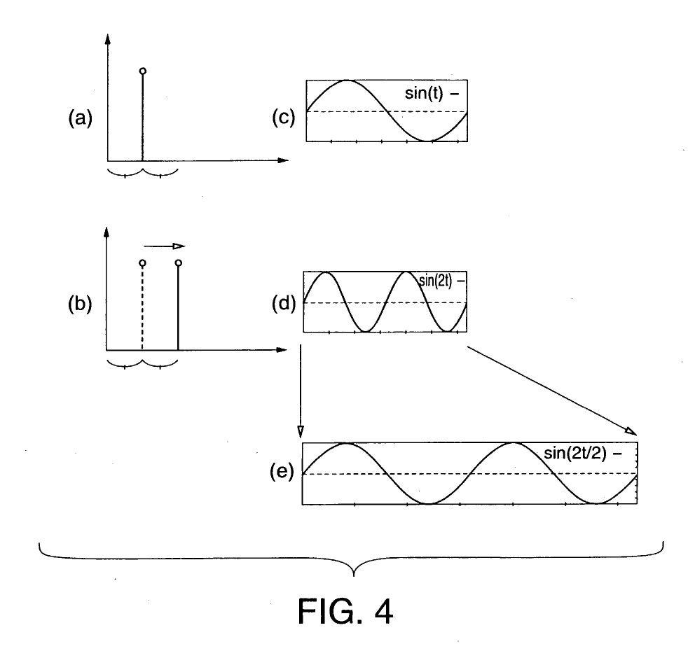

A sine-wave signal has a frequency spectrum such as shown in FIG. 4(a). Remapping this frequency spectrum in double the same as for the typical audio signal gives a frequency spectrum as being expanded as shown in FIG. 4(b).

Frequency-domain to time-domain (FT/DT) conversion to the frequency spectrum in FIG. 4(a) produces a digital audio signal shown in FIG. 4(c). FD/TD conversion to the double-remapped frequency spectrum in FIG. 4(b) produces a digital audio signal shown in FIG. 4(d)

The digital audio signal in FIG. 4(d) has a 2-cycle waveform for the same time-domain as that in FIG. 4(c), because of frequency-spectrum double remapping.

Digital-to-analog conversion to the digital audio signal in FIG. 4(d) at a sampling frequency one-half of the frequency in FIG. 4(d) produces an analog audio signal such as shown in FIG. 4(e).

Variable-speed reproduction to an encoded digital audio signal in this present invention as described with reference to FIGS. 4(a) to 4(e) offers natural sounds. In other words, users can hardly notice that the sounds have been subjected to (1/N× speed)-reproduction. This is because such a (1/N× speed)-reproduced sound will not be shifted to a bass range, according to an embodiment of the present invention.

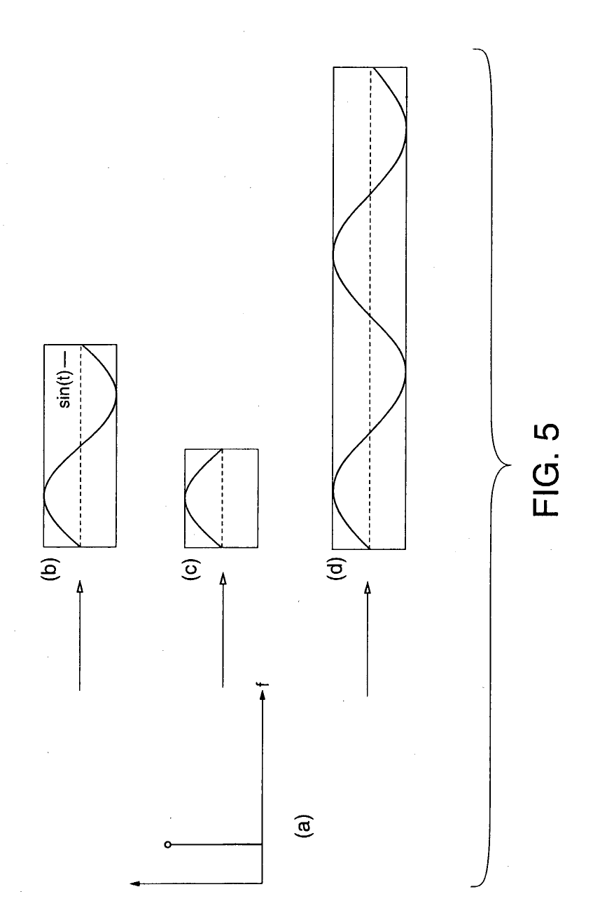

Illustrated in FIGS. 5(a) to 5(d) are frequency-spectrum mapping andvariable-speed reproduction according to an embodiment of the present invention.

In detail, FIG. 5(a) shows a remapped frequency-spectrum component. FIGS. 5(b) to 5(d) show digital audio-signal sine waveforms under (1× speed)-, (2× speed)- and (½× speed)-reproduction, respectively.

Each sine waveform is obtained by frequency-domain to time-domain conversion to a sine-wave component of the remapped frequency-spectrum component under reproduction at respective speed.

The sine waveform in FIG. 5(c) has the same waveform as but one-half of that in FIG. 5(b) on the time axis, due to (2× speed)-reproduction.

The sine waveform in FIG. 5(d) has the same waveform as but two times longer than that in FIG. 5(b) on the time axis, due to (½× speed)-reproduction.

It is understood from FIGS. 5(b) to 5(d) that frequency-spectrum remapping in this invention offers waveforms, under variable-speed reproduction, different only in the direction of time axis from that under (1× speed)-reproduction.

In other words, the audio signals are reproduced in the same waveform over (1× speed)-, (N× speed)- and (1/N× speed)-reproduction. The pitch of the played back sound will thus not vary over (1× speed)- , (N× speed)- and (1/N× speed)-reproduction. Therefore, users will not have uncomfortable feeling under variable-speed reproduction according to the present invention.

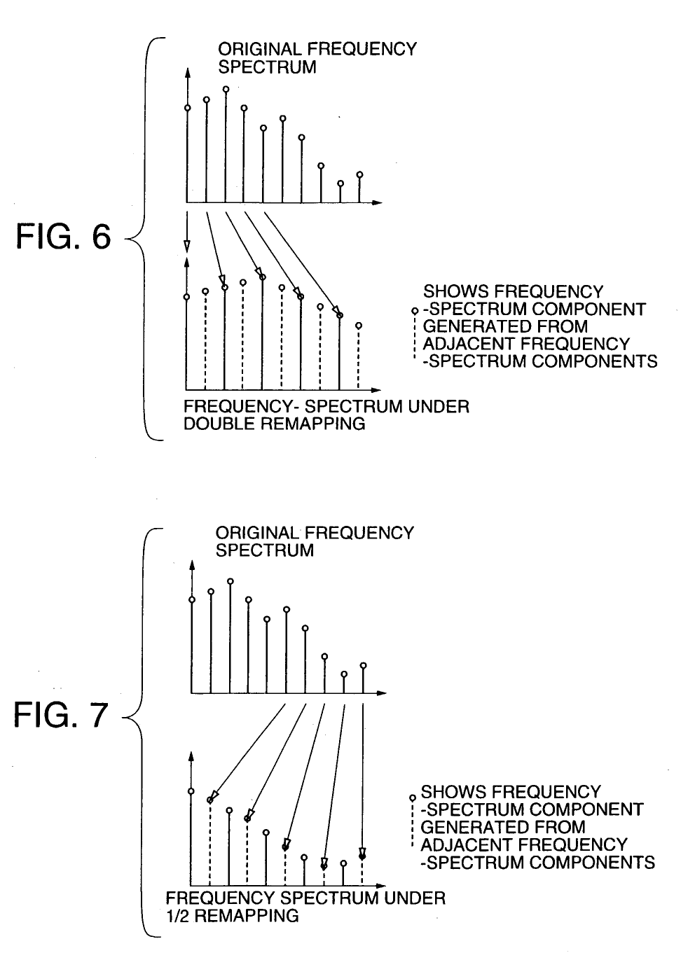

Disclosed further in detail with reference to FIGS. 6 and 7 is frequency-spectrum remapping in (1/N× speed)- and (N× speed)-reproduction according to the first embodiment the present invention.

Disclosed first is frequency-spectrum remapping in (½× speed)-reproduction with reference to FIG. 6.

The upper illustration in FIG. 6 is an original mapped frequency spectrum whereas the lower illustration is a frequency spectrum obtained by remapping the original in double.

Remapping in (½× speed)-reproduction is performed such that one-half of the total number of frequency-spectrum components are selected from a low frequency range and remapped on locations (indicated by solid lines) 2 times shifted from the original locations.

The other frequency-spectrum components indicated by dot lines in the lower illustration of FIG. 6 are obtainedbycalculation for original components not subjected to remapping based on the solid-line indicated remapped components.

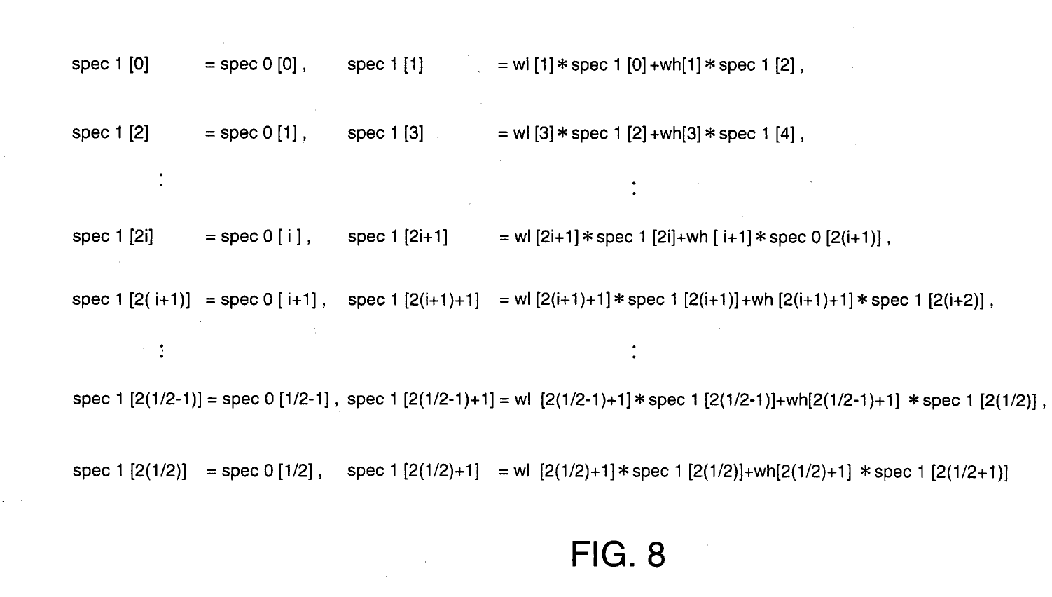

The calculation for the frequency-spectrum components not subjected to remapping will be disclosed later with reference to FIG. 8. Or, it can be performed by allocating zero to the frequency-spectrum components not subjected to remapping, like explained with reference to FIG. 2 for (½× speed)-reproduction.

Each dot-line frequency-spectrum component in the lower illustration in FIG. 6 for the original frequency-spectrum components in the upper illustration not subjected to remapping is obtained as follows:

Two frequency-spectrum component values on both sides of each original frequency-spectrum component not subjected to remapping are multiplied by a coefficient(s). The coefficient-multiplied components are then added each other to produce each dot-line frequency-spectrum component in the lower illustration in FIG. 6.

The frequency-spectrum components on, both sides of an original frequency-spectrum component not subjected to remapping contain data similar to those in the remapped frequency-spectrum components.

Therefore, users will not have uncomfortable feeling to sounds played back through remapping in the embodiment of the invention.

Disclosed next is frequency-spectrum remapping in (2× speed)-reproduction with reference to FIG. 7.

The upper illustration in FIG. 7 is an original mapped frequency spectrum, like that in FIG. 6.

Remapping in (2× speed)-reproduction is performed such that one-half of the total number of frequency-spectrum components are selected from a high frequency range and remapped over the entire components from the high frequency range as indicated by solid lines in the lower illustration in FIG. 7. The locations of these solid lines correspond to the dot lines in the lower illustration in FIG. 6.

Frequency-spectrum components indicated by dot lines in the lower illustration in FIG. 7 for those not subjectedto remapping can also be obtained by allocation of zero, like in (½× speed)-reproduction explained with reference to FIG. 2.

Or, each dot-line frequency-spectrum component in the lower illustration in FIG. 7 can be is obtained as follows:

Two frequency-spectrum component values on both sides of each original frequency-spectrum component not subjected to remapping are multiplied by a coefficient(s). The coefficient-multiplied components are then added each other to produce each dot-line frequency-spectrum component in the lower illustration in FIG. 7.

The remapping in (2× speed)-reproduction thus offers interpolated frequency-spectrum components as indicated by the dot lines in the lower illustration in FIG. 7.

Therefore, remapping in this invention allows high-quality sounds under (2× speed)-reproduction, like (1× speed)-reproduction, and hence users will not have uncomfortable feeling to the played back sounds.

Frequency-spectrum components not subjected to remapping are allocated zero in a first example of remapping explained with reference to FIG. 2. In detail, zero is allocated to each odd-number spec1 component (spec1 [2i+1]=0).

Multiplication of spec1 [2i] and spec1 [2(i+1)] by a coefficient(s), on both sides of spec1 [2i+1] achieves enhanced sound quality under (1/N× speed)-reproduction.

A second example of remapping is shown in FIG. 8 in which speco[i] is an original i-th frequency-spectrum component, specl[i] is a remapped i-th frequency-spectrum component and I is the total number of spectrum components.

Coefficients for frequency-spectrum components on both sides of a component j not to be subjected to remapping are expressed as wl[j] and wh[j] to avoid shortage of remapped components.

The coefficients wl[j] and wh[j] are determined in accordance with the distances of indices between spec1[j] and the components on both sides to be subjected to remapping.

Coefficients for every component j in (½× speed)-reproduction are determined as:

wl[j]=½, wh[j]=½

Coefficients for (k=0 to I/3) in (½× speed)-reproduction are determined as:

wl[3k+1]=⅔, wh[3k+1]=⅓

wl[3k+2]=⅓, wh[3k+2]=⅔

As disclosed above, frequency-spectrum remapping in this invention involves generation of remap-able frequency-spectrum components from those on both sides of each component not subjected to remapping to compensate for shortage of remapped components.

This remapping technique achieves further enhanced sound quality under (½× speed)-reproduction (FIG. 6) and (2× speed)-reproduction (FIG. 7) to encoded digital audio signals.

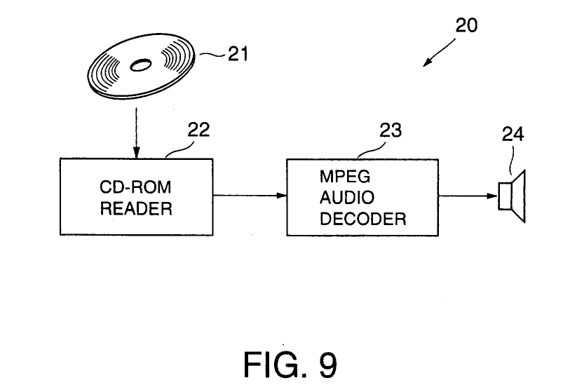

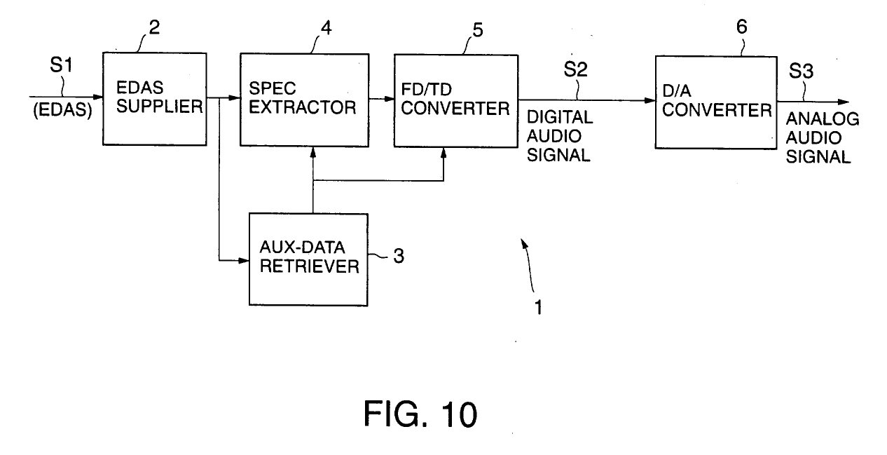

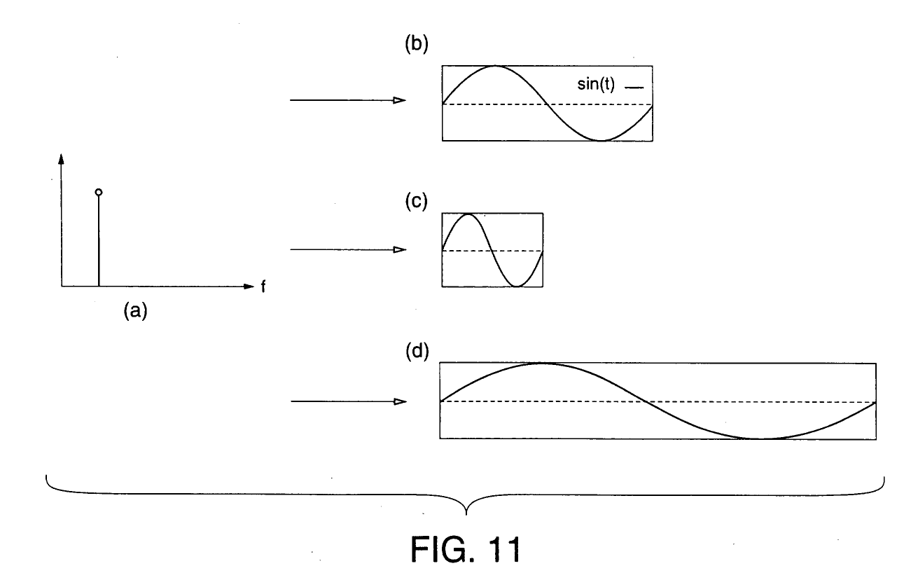

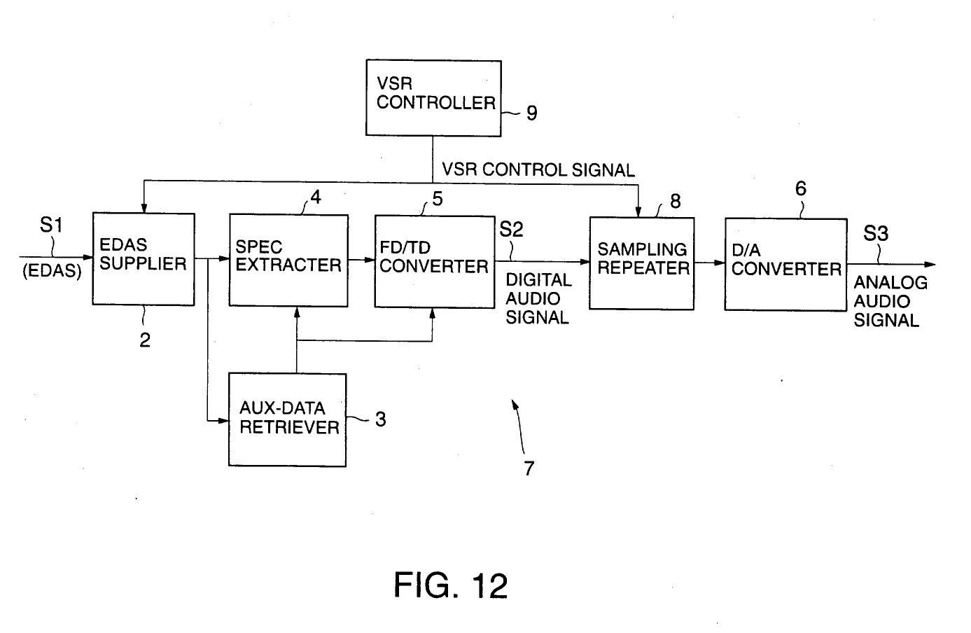

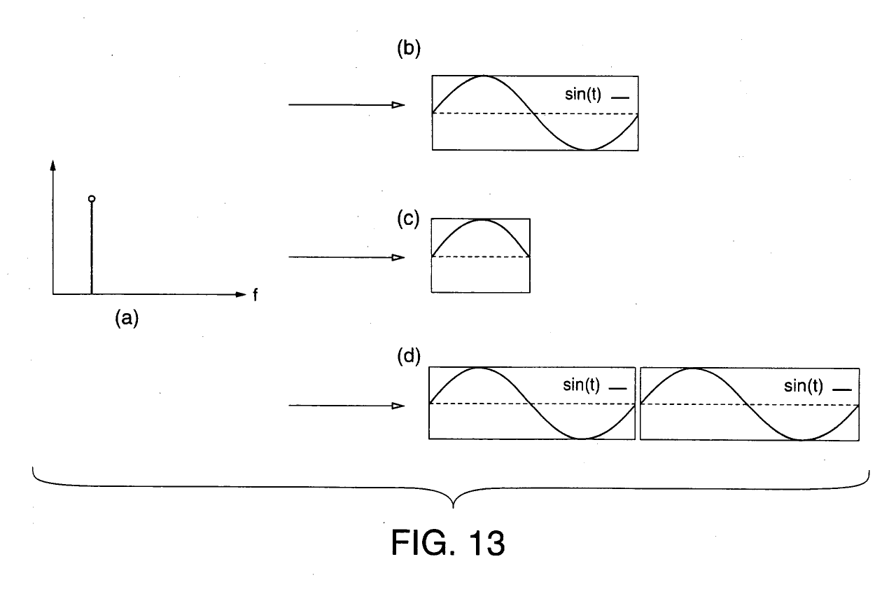

A variable-speed reproducing apparatus for reproducing encoded digital audio signals equipped with the circuitry shown in FIG. 1 and employing reproduction techniques disclosed above can be applied to an audio reproduction system such as shown in FIG. 9.

An audio reproduction system 20 is equipped with a CD-ROM reader 22 for retrieving MPEG audio signals from a CD-ROM (Compact Disc-Read Only Memory) 21; an MPEG audio decoder 23 for accepting encoded digital audio signals from the reader 22 and reproducing analog audio signals by (1× speed)-, (1/N× speed)- or (N× speed)-reproduction; and a speaker 24 for playing back sounds based on the reproduced digital or analog audio signals.

Encoded digital audio signals can be decoded and played back at a desired speed through the audio reproduction system 20 equipped with the MPEG audio decoder 23 which employs the variable-speed reproducing apparatus in this invention.

Sounds based on decoded MPEG audio signals from the MPEG audio decoder 23 under either (N× speed) or (1/N× speed)-reproduction will have pitches of the same level as sounds under (1× speed)-reproduction.

The sounds under variable-speed reproduction are completely different from slow or drawling sounds at low pitch, and rapid or gallop sounds at high pitch often occurring when played back under known variable-speed reproduction.

Therefore, the embodiment of the present invention achieves sound quality under either (N× speed) or (1/N× speed)-reproduction almost the same as under (1× speed)-reproduction.

As disclosed above in detail, the variable-speed reproduction apparatus for reproducing an encoded digital audio signal, according to the embodiment of the present invention, is equipped with a signal supplier to accept an input encoded digital audio signal with a frequency spectrum per block of the encoded audio and output the encoded digital audio signal at a desired speed and a frequency-spectrum processor to perform mapping to frequency-spectrum components of the output encoded digital audio signal based on the desired speed, thus generating a processed frequency spectrum.

The embodiment of the present invention therefore offers low-cost high-quality variable-speed reproduction apparatus, achieving high-quality sound variable-speed reproduction with the same pitch level as (1× speed)-reproduction.

What is claimed is:

1. A variable-speed reproduction apparatus for reproducing an encoded digital audio signal comprising:
a signal supplier to accept an input of an encoded digital audio signal with a frequency spectrum per block of the encoded digital audio signal and output the encoded digital audio signal at a desired speed; and
a frequency-spectrum processor to perform mapping to frequency-spectrumcomponentsof theoutputencodeddigitalaudio signal based on the desired speed, thus generating a processed frequency spectrum.

2. The variable-speed reproduction apparatus according to claim 1, wherein
the signal supplier supplies the encoded digital audio signal to the frequency-spectrum processor at a speed 1/N times lower than an original speed at which the digital audio signal has been encoded (N being a positive integer), and
the frequency-spectrum processor performs remapping frequency-spectrum components from low to 1/N in frequency among the frequency-spectrum components of the output encoded digital audio signal onto locations N times apart from original spectrum locations and allocating zeros to frequency-spectrum components on un-remapped locations, to generate the processed frequency spectrum.

3. The variable-speed reproduction apparatus according to claim 2, wherein, N being 2,
the signal supplier supplies the encoded digital audio signal to the frequency-spectrum processor at a speed ½ times lower than the original speed, and
the frequency-spectrum processor performs remapping the frequency-spectrum components from low in frequency for ½ smaller than a total number of the frequency-spectrum components onto locations 2 times apart from the original locations.

4. The variable-speed reproduction apparatus according to claim 1, wherein
the signal supplier supplies the encoded digital audio signal to the frequency-spectrum processor at a speed 1/N times lower than an original speed at which the digital audio signal has been encoded (N being a positive integer), and
the frequency-spectrum processor performs remapping frequency-spectrum components from low to 1/N in frequency among the frequency-spectrum components of the output encoded digital audio signal onto locations N times apart from original spectrum locations and calculating first frequency-spectrum components on un-remapped locations using the remapped frequency-spectrum components, to generate the processed frequency spectrum.

5. The variable-speed reproduction apparatus according to claim 4, wherein
the frequency-spectrum processor calculates the first frequency-spectrum components using remapped second frequency-spectrum components located on both sides of each first frequency-spectrum component, to generate the processed frequency spectrum.

6. The variable-speed reproduction apparatus according to claim 5, wherein
the frequency-spectrum processor multiplies the remapped second frequency-spectrum components by coefficients and adds the coefficient-multiplied second components each other based on the un-remapped locations of the first frequency-spectrum components to be calculated and a spectrum distance between each first frequency-spectrum component and each second remapped frequency-spectrum component, the added coefficient-multiplied second components being used as each first frequency-spectrum component to be calculated, to generate the processed frequency spectrum.

7. The variable-speed reproduction apparatus according to claim 4, wherein, N being 2,
the signal supplier supplies the encoded digital audio signal to the frequency-spectrum processor at a speed ½ times lower than the original speed, and the frequency-spectrum processor performs remapping the frequency-spectrum components of low in frequency for ½ smaller than a total number of the frequency-spectrum components onto locations 2 times apart from the original locations.

8. The variable-speed reproduction apparatus according to claim 1, wherein
the signal supplier supplies the encoded digital audio signal to the frequency-spectrum processor at a speed N times higher than an original speed at which the digital audio signal has been encoded (N being a positive integer),
the frequency-spectrum processor performs remapping frequency-spectrum components from high to 1/N in frequency among the frequency-spectrum components of the output encoded digital audio signal onto locations N times apart from original spectrum locations and allocating zeros to frequency-spectrum components on un-remapped locations, to generate the processed frequency spectrum.

9. The variable-speed reproduction apparatus according to claim 8, wherein, N being 2,
the signal supplier supplies the encoded digital audio signal to the frequency-spectrum processor at a speed 2 times higher than the original speed, and
the frequency-spectrum processor performs remapping the frequency-spectrum components of high in frequency for 2 times more than a total number of the frequency-spectrum components onto locations 2 times apart from the original locations.

10. The variable-speed reproduction apparatus according to claim 1, wherein
the signal supplier supplies the encoded digital audio signal to the frequency-spectrum processor at a speed N times higher than an original speed at which the digital audio signal has been encoded (N being a positive integer), and
the frequency-spectrum processor performs remapping frequency-spectrum components from high to 1/N in frequency among the frequency-spectrum components of the output encoded digital audio signal onto locations N times apart from original spectrum locations and calculating first frequency-spectrum components on un-remapped locations using the remapped frequency-spectrum components, to generate the processed frequency spectrum.

11. The variable-speed reproduction apparatus according to claim 10, wherein
the frequency-spectrum processor calculates the first frequency-spectrum components using remapped second frequency-spectrum components, to generate the processed frequency spectrum.

12. The variable-speed reproduction apparatus according to claim 11, wherein
the frequency-spectrum processor multiplies the remapped second frequency-spectrum components by coefficients and adds the coefficient-multiplied second components each other based on the un-remapped locations of the first frequency-spectrum components to be calculated and a spectrum distance between each first frequency-spectrum component and each second remapped frequency-spectrum component, the added coefficient-multiplied second components being used as each first frequency-spectrum component to be calculated, to generate the processed frequency spectrum.

13. The variable-speed reproduction apparatus according to claim 7, wherein, N being 2,
the signal supplier supplies the encoded digital audio signal to the frequency-spectrum processor at a speed ½ times lower than the original speed, and
the frequency-spectrum processor performs remapping the frequency-spectrum components of low in frequency for ½ smaller than a total number of the frequency-spectrum components onto locations 2 times apart from the original locations.

14. The variable-speed reproduction apparatus according to claim 1 further comprising:
an auxiliary-data retriever to retrieve an auxiliary data from the encoded digital audio signal output from the signal supplier;
a frequency-spectrum extractor to extract a frequency-spectral data carried by the encoded digital audio signal based on the auxiliary data, the frequency-spectral data being supplied to the frequency-spectrum processor;
a frequency-domain to time-domain converter to convert a frequency component of the encoded digital audio signal into a time-domain component based on the processed frequency spectrum and the auxiliary data, thus outputting a digital audio signal;
a digital-to-analog converter to convert the digital audio signal into an analog audio signal; and
a variable-speed reproduction controller to supply a variable-speed reproduction control signal to the signal supplier, the frequency-spectrum processor and the digital-to-analog converter.

15. An audio reproduction system having a signal reader to retrieve an encoded audio digital signal from a storage medium storing MPEG audio signals, an MPEG audio decoder to decode the retrieved encoded audio digital signal at a desired speed among an original speed the same as a speed at which the MPEG audio signals have been stored in the storage medium, a speed of 1/N times lower than the original speed and a speed of N times higher than the original speed (N being a positive integer), and a speaker to output audio based on a digital or an analog audio signal reproduced by the MPEG audio decoder,
wherein the MPEG audio decoder comprises:
a signal supplier to accept the encoded digital audio signal with a frequency spectrum per block of the encoded audio and output the encoded digital audio signal at the desired speed; and
a frequency-spectrum processor to perform mapping to frequency-spectrum components of the output encoded digital audio signal based on the desired speed, thus generating a processed frequency spectrum.

16. The audio reproduction system according to claim 15, wherein
the signal supplier supplies the encoded digital audio signal to the frequency-spectrum processor at a speed 1/N times lower than the original speed, and
the frequency-spectrum processor performs remapping frequency-spectrum components from low to 1/N in frequency among the frequency-spectrum components of the output encoded digital audio signal onto locations N times apart from original spectrum locations and allocating zeros to frequency-spectrum components on un-remapped locations, to generate the processed frequency spectrum.

17. The audio reproduction system according to claim 15, wherein
the signal supplier supplies the encoded digital audio signal to the frequency-spectrum processor at a speed 1/N times lower than the original speed, and the frequency-spectrum processor performs remapping frequency-spectrum components from low to 1/N in frequency among the frequency-spectrum components of the output encoded digital audio signal onto locations N times apart from original spectrum locations and calculating first frequency-spectrum components on un-remapped locations using the remapped frequency-spectrum components, to generate the processed frequency spectrum.

18. The audio reproduction system according to claim 15, wherein
the signal supplier supplies the encoded digital audio signal to the frequency-spectrum processor at a speed N times higher than the original speed, and
the frequency-spectrum processor performs remapping frequency-spectrum components from high to 1/N in frequency among the frequency-spectrum components of the output encoded digital audio signal onto locations N times apart from original spectrum locations and allocating zeros to frequency-spectrum components on un-remapped locations, to generate the processed frequency spectrum.

19. The audio reproduction system according to claim 15, wherein
the signal supplier supplies the encoded digital audio signal to the frequency-spectrum processor at a speed N times higher than the original speed, and the frequency-spectrum processor performs remapping frequency-spectrum components from high to 1/N in frequency among the frequency-spectrum components of the output encoded digital audio signal onto locations N times apart from original spectrum locations and calculating frequency-spectrum components on un-remapped locations using the remapped frequency-spectrum components, to generate the processed frequency spectrum.

20. The audio reproduction system according to claim 15, wherein the MPEG audio decoder further comprises:
an auxiliary-data retriever to retrieve an auxiliary data from the encoded digital audio signal output from the signal supplier;
a frequency-spectrum extractor to extract a frequency-spectral data carried by the encoded digital audio signal based on the auxiliary data, the frequency-spectral data being supplied to the frequency-spectrum processor;
a frequency-domain to time-domain converter to convert a frequency component of the encoded digital audio signal into a time-domain component based on the processed frequency spectrum and the auxiliary data, thus outputting a digital audio signal;
a digital-to-analog converter to convert the digital audio signal into an analog audio signal; and
a variable-speed reproduction controller to supply a variable-speed reproduction control signal to the signal supplier, the frequency-spectrum processor and the digital-to-analog converter.
